(19) United States
(12) Patent Application Publication
(10) Pub. No.: US 2024/0334553 A1
(43) Pub. Date: Oct. 3, 2024

(54) RESISTIVE HEATER SUBSTRATES AND METHODS OF MANUFACTURING RESISTIVE HEATER SUBSTRATES

(71) Applicant: CORNING INCORPORATED, Corning, NY (US)

(72) Inventors: Douglas Munroe Beall, Painted Post, NY (US); Vishwanath Ganpat Deshmane, Chesterbrook, PA (US); Cheryl Barnett Gross, Columbia Cross Roads, PA (US)

(21) Appl. No.: 18/617,797

(22) Filed: Mar. 27, 2024

Related U.S. Application Data
(60) Provisional application No. 63/455,366, filed on Mar. 29, 2023.

(51) Int. Cl. H05B 3/18; F01N 3/20; F01N 3/28

(52) U.S. Cl. CPC H05B 3/18; F01N 3/2026; F01N 3/2825; F01N 2370/02; F01N 2510/08; H05B 2203/017; H05B 2203/024

(57) ABSTRACT

The present disclosure is directed to ceramic honeycomb bodies, systems incorporating such honeycomb bodies, and methods of preparing and/or manufacturing such honeycomb bodies. The articles, systems, and methods of the present disclosure find particular application in reducing cold-start emissions in gasoline- and diesel-powered engines. More specifically, the ceramic honeycomb bodies of the present disclosure provide electrode attachment points with improved mechanical and electrical properties, which enable consistent and sustainable electrode coupling even under harsh conditions such as in exhaust aftertreatment systems.

### CROSS REFERENCE TO RELATED APPLICATION

This application claims the benefit of priority under 35 U.S.C. § 119 of U.S. Provisional Application Ser. No. 63/455,366, filed on Mar. 29, 2023, the content of which is relied upon and incorporated herein by reference in its entirety.

### FIELD OF THE DISCLOSURE

The present disclosure relates generally to composite honeycomb substrates and resistive heater assemblies for use in fluid aftertreatment systems, and methods of preparing and/or manufacturing said substrates.

### BACKGROUND

In modern gasoline- and diesel-powered engines, an exhaust aftertreatment system may be used to reduce the emissions produced during operation of the engines. These emissions can include, but are not limited to, particulate matter, volatile organic compounds, nitrogen oxides, carbon monoxide, carbon dioxide, sulfur dioxide, and the like. In some aftertreatment systems, a catalyst-containing substrate may be used to trap, reduce, or eliminate one or more of these undesirable emissions. However, during the first 20 to 60 seconds after engine ignition, the catalyst-containing substrates do not reach full efficiency until the engine exhaust heats the catalyst up to the temperature at which catalytic reactions are initiated (i.e., the “light-off” temperature of the catalyst). As a result, cold start emissions (i.e., the emissions produced during the first 20 to 60 seconds after engine ignition) continue to represent the most significant contribution of emissions during the engine operating cycle.

### SUMMARY OF THE DISCLOSURE

According to an embodiment of the present disclosure, a resistive heater body is provided. The resistive heater body comprises: a plurality of channels formed by interconnected walls, wherein the interconnected walls comprise a ceramic-containing material; a first conductive base comprising: (i) a first portion infiltrating a first porous peripheral region of the resistive heater body, and (ii) a second portion coating a first surface of the resistive heater body adjacent to the first porous peripheral region, wherein the second portion is formed from an organometallic mixture; and a second conductive base comprising: (i) a first portion infiltrating a second porous peripheral region of the resistive heater body, and (ii) a second portion coating a second surface of the resistive heater body adjacent to the second porous peripheral region, wherein the second portion is formed from the organometallic mixture.

In an aspect, the plurality of channels are cell channels and the interconnected walls are cell walls.

In an aspect, the plurality of channels extend in an axial direction through the resistive heater body from a first end face of the resistive heater body to a second end face of the resistive heater body.

In an aspect, the interconnected walls of the resistive heater body are formed from a conductive ceramic material and have an average bulk porosity of from about 40% to about 80%.

In an aspect, the first portion of the first conductive base and the first portion of the second conductive base are formed from a slurry comprising metal and/or metal alloy particles.

In an aspect, the interconnected walls have a median pore diameter of about 5 μm to about 35 μm and the metal and/or metal alloy particles have a median particle diameter of from about 1 μm to about 35 μm.

In an aspect, the interconnected walls have a median pore diameter that is greater than a median particle diameter of the metal and/or metal alloy particles.

In an aspect, the interconnected walls of the resistive heater body are formed from (i) a first phase of a porous material defining an internal, interconnected porosity, and (ii) a second phase of an electrically-conductive material that at least partially fills the internal, interconnected porosity of the first phase.

In an aspect, the internal, interconnected porosity of the first phase has a median pore diameter of from about 5 μm to about 40 μm, and the electrically-conductive material of the second phase comprises electrically-conductive particles having a median particle diameter of from about 0.5 μm to about 25 μm.

In an aspect, the organometallic mixture comprises from about 50 wt % to about 95 wt % of metal and/or metal alloy particles.

In an aspect, the metal and/or metal alloy particles comprises iron, iron alloys, chromium, chromium alloys, nickel, nickel alloys, nickel-chromium alloys, iron-chromium-aluminum (FeCrAl), iron-chromium-aluminum-yttrium (FeCrAlY), an Inconel® alloy, and/or combinations thereof.

In an aspect, the organometallic mixture comprises from about 0.1 wt % to about 5 wt % of an organic binder.

In an aspect, the organic binder comprises polyvinyl butadiene (PVB), polyvinyl acetate (PVA), polyethylene glycol (PEG), methylcellulose, and/or combinations thereof.

In an aspect, the organometallic mixture comprises from about 5 wt % to about 30 wt % of a solvent.

In an aspect, the solvent comprises at least one of an alcohol and water.

According to another embodiment of the present disclosure, a resistive heater assembly is provided. The resistive heater assembly comprises a resistive heater body, a first electrode coupled to the first conductive base of the resistive heater body, and a second electrode coupled to the second conductive base of the resistive heater body.

According to yet another embodiment of the present disclosure, a fluid treatment system is provided. The fluid treatment system comprises a resistive heater assembly as described herein.

According to another embodiment of the present disclosure, a method of selectively coating an outer periphery of a resistive heater body is provided. The method comprises: (a) masking a first end face of the resistive heater body, the resistive heater body comprising a plurality of channels formed by interconnected walls, wherein the interconnected walls comprise a ceramic-containing material; (b) mounting the resistive heater body into a vacuum fixture at the second end face of the resistive heater body; (c) while mounted to the vacuum fixture, submerging at least a portion of the resistive heater body into a slurry such that the slurry contacts at least an outer periphery of the resistive heater body, wherein the slurry comprises metal and/or metal alloy particles; (d) applying a vacuum pressure to the resistive heater body via the vacuum fixture at least while the portion of the resistive heater body is submerged in the slurry; (e) removing the resistive heater body from the slurry; and (f) drying the resistive heater body at a first temperature for a first period of time.

In an aspect, one or more steps are repeated a plurality of times.

According to still another embodiment of the present disclosure, a method of manufacturing a resistive heater body having one or more conductive bases formed at one or more outer surfaces of the resistive heater body is provided. The method comprises: (a) providing a resistive heater body, wherein the resistive heater body comprises: (i) a plurality of channels formed by interconnected walls, wherein the interconnected walls comprise a ceramic-containing material; and (ii) a conductive material infiltrating at least a first porous peripheral region of the resistive heater body; (b) applying an organometallic mixture to at least a first surface of the resistive heater body adjacent to at least the first porous peripheral region of the resistive heater body; (c) drying the resistive heater body and the applied organometallic mixture at a first temperature for a first period of time; and (d) heating the ceramic honeycomb body and the applied organometallic mixture at a second temperature for a second period of time to sinter the conductive material infiltrating at least the first porous peripheral region of the resistive heater body to the organometallic mixture and thereby form at least a first conductive base.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a flowchart illustrating a method of manufacturing a ceramic honeycomb body according to aspects of the present disclosure.

FIG. 2 is a flowchart illustrating a method of selectively skin coating a ceramic honeycomb substrate according to aspects of the present disclosure.

FIG. 3A is a first diagram illustrating a method of selectively skin coating a ceramic honeycomb substrate according to aspects of the present disclosure.

FIG. 3B is a second diagram illustrating a method of selectively skin coating a ceramic honeycomb substrate according to aspects of the present disclosure.

FIG. 3C is a third diagram illustrating a method of selectively skin coating a ceramic honeycomb substrate according to aspects of the present disclosure.

FIG. 4 is a scanning electron microscope (SEM) image of a honeycomb substrate having a selectively coated skin according to aspects of the present disclosure.

FIG. 5A is a photograph showing a ceramic honeycomb body having continuous metallic layers according to aspects of the present disclosure.

FIG. 5B is an enlarged view of the photograph showing a ceramic honeycomb body having continuous metallic layers according to aspects of the present disclosure.

FIG. 6 is a side view illustration of a ceramic honeycomb body having continuous metallic layers according to aspects of the present disclosure.

FIG. 7 is a resistive heater assembly comprising a ceramic honeycomb body according to aspects of the present disclosure.

FIG. 8 is a cross-sectional side view illustration of a fluid treatment system comprising a catalyst substrate and a resistive heater assembly according to aspects of the present disclosure.

### DETAILED DESCRIPTION OF EMBODIMENTS

One approach to reducing undesirable emissions in gasoline- and diesel-powered engines is the use of substrates and/or filters in an exhaust aftertreatment system. For example, catalyst-containing substrates may be configured in a fluid treatment system to receive exhaust from the engine prior to releasing the exhaust into the environment, whereby certain undesirable components of the exhaust are captured in a chemical reaction within the catalyst-containing substrate. However, even in fluid treatment systems having a catalyst-containing substrate, cold start emissions contribute a significant amount of undesirable emissions during a typical engine operating cycle because of the time it takes to heat-up the catalyst.

To address the issue of cold start emissions, the present disclosure is directed to resistive heater bodies, resistive heater assemblies, and methods of manufacturing such resistive heater assemblies for use in fluid treatment systems to reduce the light-off time of a catalyst in a catalyst-containing substrate of the fluid treatment system. One of the key processing steps in obtaining usable resistive heater assemblies for such applications is the attachment of electrode leads. More specifically, electrodes must be able to be attached to the resistive heater body in order to provide an electrical current and produce heat. However, the attachment of electrodes can be particularly difficult where direct sintering of the electrodes securely to the resistive heater body is not feasible, for example, when the resistive heater body comprises a composite material as described in International Patent Application No. PCT/US2022/038439, filed on Jul. 27, 2022, the entire contents of which are incorporated by reference as if fully set forth herein.

Further, while a secure attachment of the electrode necessary to conduct electrical current through the resistive heater body and generate resistive heating, such attachments may also be susceptible to failure due to the high temperature heating cycling that the resistive heater body undergoes and harsh environmental conditions to which the resistive heater body is exposed during operation. Failures at the electrode attachment locations can be exacerbated in applications where there is a high coefficient of thermal expansion between the electrode and the resistive heater body.

According to one embodiment of the present disclosure, a method of manufacturing a resistive heater body is described. Advantageously, the resistive heater body is manufactured to have one or more conductive bases formed at an outer periphery of the resistive heater body. More specifically, the manufactured resistive heater body can comprise: (i) a plurality of channels formed by a plurality of intersecting walls; (ii) a first conductive base comprising (A) a first portion infiltrating a first porous region of the resistive heater body, and (B) a second portion coating a first outer surface of the resistive heater body adjacent to the first porous region; and (iii) a second conductive base comprising (A) a first portion infiltrating a second porous region of the resistive heater body, and (B) a second portion coating a second outer surface of the resistive heater body adjacent to the second porous region. As described herein, the second portion of each conductive base is physically bonded to the first portion of the corresponding conductive base such that the first and second portions are in electrical communication with one another. In further embodiments, the first and second conductive bases do not contact each other but are in electrical communication with one another and provide suitable contacts for electrode attachment.

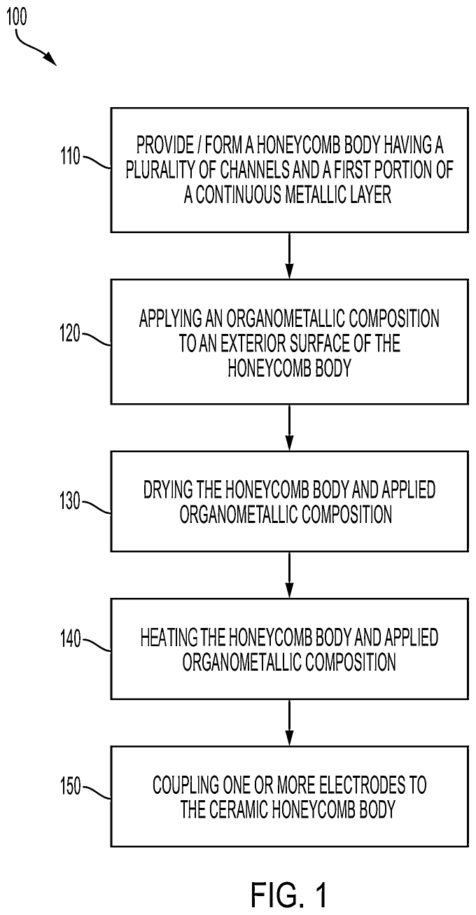

For example, with reference to FIG. 1, a method 100 of manufacturing a resistive heater body having a continuous metallic layer formed at an outer periphery of the resistive heater body is illustrated according to certain aspects of the present disclosure. The method 100 comprises: in a step 110, forming and/or otherwise providing a resistive heater body; in a step 120, applying an organometallic mixture to at least a first outer surface of the resistive heater body; in a step 130, drying the resistive heater body and the applied organometallic mixture at a first temperature for a first period of time; and in a step 140, heating the resistive heater body and the applied organometallic mixture at a second temperature for a second period of time to form one or more conductive bases configured to provide suitable electrode attachment points.

More specifically, in step 110, the method 100 comprises forming and/or otherwise providing a resistive heater body having a plurality of openings formed by intersecting walls. In embodiments, intersecting walls of the resistive heater body is formed from a ceramic-containing material, as described in more detail below. In particular embodiments, the resistive heater body provided and/or formed in the step 110 is an unfired resistive heater body (i.e., the part is in a green state). In other embodiments, the resistive heater body provided and/or formed in the step 110 is a fired resistive heater body. Put another way, the resistive heater body provided and/or formed in the step 110 may or may not be fired before proceeding to the step 120.

As described herein, the resistive heater body comprises a plurality of openings formed by interconnected walls that enable a fluid flow (e.g., exhaust gas, etc.) to pass through the openings. In embodiments, the plurality of openings and interconnected walls of the resistive heater body can be formed from a foamed structure, a lattice structure, a wire structure, a mesh structure, a honeycomb structure, and/or the like.

In particular embodiments, the plurality of openings can be channels and the interconnected walls can be intersecting walls. For example, in some embodiments, the resistive heater body comprises a plurality of cell channels formed by an array of intersecting cell walls. The plurality of cell channels can be parallel to one another and extend in an axial direction through the resistive heater body between opposite end faces of the body (e.g., from a first end face to a second end face). The plurality of cell channels generally have a rectangular cross-sectional shape. However, in embodiments, the cell channels can have other regular or irregular cross-sectional shapes, including but not limited to, triangular, heptagonal, hexagonal, octagonal, trapezoidal, diamond, circular, ellipsoidal, other polygonal shapes, and/or combinations thereof. The corners of the cell channels can be radiused, filleted, chamfered, beveled, and/or combinations thereof. In embodiments, these arrangements of openings and intersecting walls may be referred to as a honeycomb body or honeycomb structure.

In specific embodiments, the resistive heater body has a defined channel density measured in terms of the number of cells per square inch (cpsi). In some embodiments, the channel density is from about 100 cpsi (31 cells/cm²) to about 600 cpsi (186 cells/cm²), including from about 100 cpsi to about 200 cpsi, from about 200 cpsi to about 300 cpsi, from about 300 cpsi to about 400 cpsi, from about 400 cpsi to about 500 cpsi, from about 500 cpsi to about 600 cpsi, and any combination of endpoints thereof.

In still further embodiments, the interconnected walls of the resistive heater body can have a defined transverse wall thickness (Tw) of from about 2 mils to about 14 mils, including from about 2 mils to about 3 mils, from about 3 mils to about 4 mils, from about 4 mils to about 5 mils, from about 5 mils to about 6 mils, from about 6 mils to about 7 mils, from about 7 mils to about 8 mils, from about 8 mils to about 9 mils, from about 9 mils to about 10 mils, from about 10 mils to about 11 mils, from about 11 mils to about 12 mils, from about 12 mils to about 13 mils, from about 13 mils to about 14 mils, and any combination of endpoints thereof.

Additionally, the peripheral shape of the resistive heater body can be circular, rectangular, triangular, heptagonal, hexagonal, octagonal, trapezoidal, diamond, circular, ellipsoidal, or another polygonal shape. That is, the resistive heater body may have a cross-sectional shape that is circular, rectangular, triangular, heptagonal, hexagonal, octagonal, trapezoidal, diamond, circular, ellipsoidal, or another polygonal shape. In embodiments, the resistive heater body comprises a skin formed at an outer periphery of the resistive heater body that provides additional structural support.

As described herein, the interconnected walls of the resistive heater body (or a portion thereof) provided and/or formed in the step 110 comprise a conductive material that infiltrates at least an outer/peripheral portion of the resistive heater body. Put another way, in embodiments, a conductive material can be embedded within the interconnected walls of the resistive heater body or a portion thereof, such as an outer/peripheral portion of the resistive heater body. In particular embodiments, the conductive material that infiltrates the interconnected walls of the resistive heater body can form a portion of one or more conductive bases that are suitable for electrode attachment, as described in more detail below.

According to one embodiment of the present disclosure, the interconnected walls of the resistive heater body provided and/or formed in the step 110 are formed from a conductive ceramic material (CCM). That is, the ceramic-containing material used to form the interconnected walls of the resistive heater body can be a conductive ceramic material. In embodiments, the conductive ceramic material comprises a metal-silicide, a metal-carbide, a metal-nitride, and/or the like. In specific embodiments, the conductive ceramic material is molybdenum disilicide (MoSi₂) and/or silicon carbide (SiC).

In embodiments, a resistive heater body is formed from a conductive ceramic material by forming a batch mixture comprising the conductive ceramic material and one or more additives, extruding the batch mixture to form the desired structure, the drying structure, and optionally firing the structure at a sufficient temperature to sinter and/or react the conductive ceramic material into a monolithic body. In particular embodiments, the batch mixture comprises one or more additives, such as a binder, lubricant, liquid carrier, and/or the like.

In further embodiments, the batch mixture comprises a pore former used to impart a desired porosity to the interconnected walls of the resistive heater body once formed. That is, the interconnected walls formed from a conductive ceramic material can have a predetermined average porosity. In particular embodiments, at least the outer/peripheral portions (e.g., the skin) of the resistive heater body has a predetermined average porosity.

In embodiments, the interconnected walls have an average bulk porosity of at least about 40%, including at least about 45%, about least about 50%, at least about 55%, at least about 60%, at least about 65%, at least about 70%, at least about 75%, at least about 80%, at least about 85%, and/or at least about 90%. In some embodiments, the honeycomb substrate can have an average bulk porosity of from about 40% to about 90%, including from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, and any combination of endpoints thereof.

In further embodiments, the interconnected walls have a median pore diameter of at least about 5 μm, including at least about 10 μm, at least about 15 μm, at least about 20 μm, and/or at least about 25 μm. In some embodiments, the interconnected walls have a median pore diameter of from about 5 μm to about 10 μm, from about 10 μm to about 15 μm, from about 15 μm to about 20 μm, from about 20 μm to about 25 μm, and any combination of endpoints thereof.

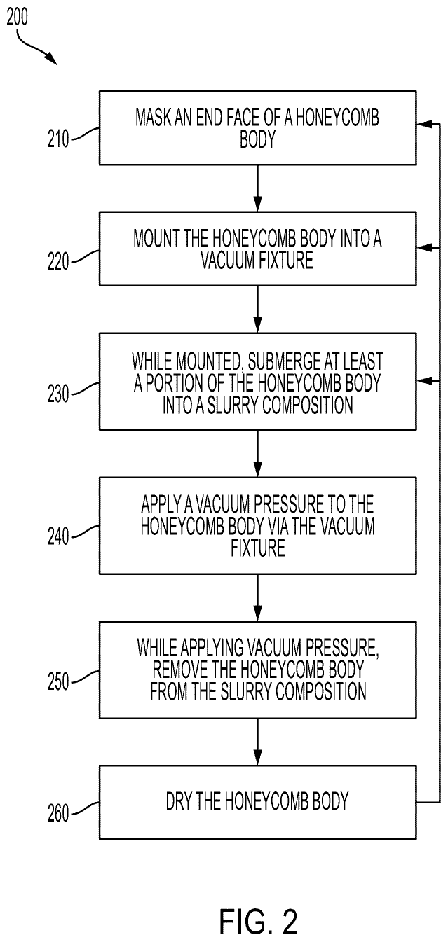

In still further embodiments, the resistive heater body provided and/or formed in the step 110 is selectively skin-coated using a slurry comprising conductive metal and/or metal alloy particles. According to such embodiments, the conductive metal and/or metal alloy particles infiltrate at least an outer/peripheral portion of the resistive heater body based on the defined porosity of the interconnected walls of the resistive heater body. For example, as discussed with respect to FIG. 2, a resistive heater body can be formed by extruding a batch mixture comprising a conductive ceramic material that is subsequently subjected to a slurry comprising conductive metal and/or metal alloy particles that infiltrate at least a portion of the bulk porosity of the interconnected walls and also coats a skin of the resistive heater body.

According to another embodiment of the present disclosure, the interconnected walls of the resistive heater body provided and/or formed in the step 110 are formed from a metal ceramic composite material that comprises (i) a first phase of a porous material defining an internal, interconnected porosity, and (ii) a second phase of a metal and/or metal alloy material that at least partially fills the internal, interconnected porosity of the first phase. That is, the ceramic-containing material used to form the interconnected walls of the resistive heater body can be a metal ceramic composite material. In embodiments, the material of the first phase can be extruded and processed (e.g., dried, fired, etc.) to form a substrate having an internal, interconnected porosity. As used herein, the term “internal, interconnected porosity” refers to a three-dimensional interconnected structure of void spaces distributed throughout the structure formed by the first phase of the metal ceramic composite material.

In embodiments, the first phase of the metal ceramic composite material forming the interconnected walls comprise a porous ceramic, a porous glass-ceramic, and/or a porous glass material. In specific embodiments, the porous material of the first phase comprises cordierite, aluminum titanate, alumina, silicon carbide, silicon nitride, mullite, sapphirine, spinel, calcium aluminate, zirconium phosphate, β-spodumene, β-eucryptite (LiAlSiO₄), a cordierite-glass ceramic, fused silica, doped fused silica, and/or the like, including combinations thereof.

Advantageously, the first phase is formed as a continuous, three-dimensional, interconnected structure (e.g., a monolithic body made from a porous material). In embodiments, this structure/monolithic body facilitates manufacture of the composite structures described herein by providing an initial structure that supports and shapes the second phase during infiltration and sintering. Additionally, the structure of the monolithic body also provides tailorabiltiy of the electrical resistance/conductivity of the resulting composite structure based on the characteristics of the interconnected porosity of the first phase (e.g., median pore diameter, porosity %, pore size distribution, etc.). Thus, once manufactured, the combination of a first continuous, three-dimensional, interconnected phase intertwined with a second continuous, three-dimensional, interconnected phase results in high durability, environmental resistance, strength, and thermal cycling ability for the resulting composite structure.

As such, the metal ceramic composite material can comprise a second phase formed from an electrically-conductive material. In embodiments, the electrically-conductive material is introduced to the monolithic body/structure to form a resistive heater body. Advantageously, the second phase forms a continuous, three-dimensional, interconnected, electrically-conductive phase that provides a continuous, three-dimensional, electrically-conductive path laterally across the resistive heater body (in a direction perpendicular to the axial direction), such as between a first side and an opposite second side of the resistive heater body.

In particular embodiments, the electrically-conductive material of the second phase is a metal material, such as a sintered metal that is created by sintering together metal particles that have been deposited within the internal, interconnected porosity of the first phase. Put another way, the electrically-conductive material of the second phase may be formed from a mixture comprising electrically-conductive particles and one or more additives (e.g., a binder, lubricant, liquid carrier, and/or the like). In embodiments, the metal material of the second phase can be an Fe-containing alloy, an Fe—Cr alloy, an Fe—Al alloy, an Fe—Ni alloy, an Inconel® alloy, a W—Co alloy, and/or the like, including combinations thereof.

In embodiments, the electrically-conductive material of the second phase can be an electrically-conductive, oxidation resistant, high melting point metal or metal-containing material. For example, in some embodiments, the electrically-conductive material can be a metal or metal-containing material having a melting point of greater than about 1,200° C., greater than about 1,300° C., or even greater than 1,400° C. In some embodiments, the electrically-conductive material can be a metal or metal-containing material also having an electrical resistivity of less than about 1.2×10⁻⁶ Ohm-m, less than about 1.1×10⁻⁶ Ohm-m, or even less than about 1.0×10⁻⁶ Ohm-m, as measured by ASTM B193-20.

In embodiments, other suitable materials for the second phase can be used, including silicon carbide (SiC), molybdenum disilicide (MoSi₂), SnO₂, ZrO₂, and the like.

In embodiments, the interconnected walls formed by the first phase of the metal ceramic composite can have an average bulk porosity of between about 40% and about 90%, absent the second phase (i.e., prior to being impregnated with the conductive material of the second phase). In embodiments, the average bulk porosity is at least about 40%, including at least about 45%, about least about 50%, at least about 55%, at least about 60%, at least about 65%, at least about 70%, at least about 75%, at least about 80%, at least about 85%, and/or at least about 90%. In some embodiments, the first phase can have an average bulk porosity of from about 40% to about 90%, including from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, and any combination of endpoints thereof.

In embodiments, the interconnected walls have a median pore diameter of at least about 5 μm, including at least about 10 μm, at least about 15 μm, at least about 20 μm, and/or at least about 25 μm. In some embodiments, the interconnected walls have a median pore diameter of from about 5 μm to about 10 μm, from about 10 μm to about 15 μm, from about 15 μm to about 20 μm, from about 20 μm to about 25 μm, from about 25 μm to about 30 μm, from about 30 μm to about 35 μm, and any combination of endpoints thereof.

In embodiments, the interconnected walls also have a defined pore size distribution (Db), which may be referred to as a breadth of the pore size distribution. In embodiments, the pore size distribution may be determined according to the following:

$$Db = \frac{d 50}{d 90 - d 10} \qquad ( Eqn . 1 )$$

where d50 is the median pore size, d90 is the size larger than the smallest 90% of the pores in the distribution, and d10 is the size larger than the smallest 10% of pores in the distribution.

In some embodiments, the pore size distribution is less than or equal to about 1.0 (i.e., Db≤1.0), or even less than or equal to about 0.75 (i.e., Db≤0.75).

In embodiments, the electrically-conductive material of the second phase comprises electrically-conductive particles having a defined median particle diameter. For example, in embodiments, the electrically-conductive particles have a median particle diameter of from about 0.5 μm to about 25 μm, including from about 0.5 μm to about 1.0 μm, from about 1 μm to about 5 μm, from about 5 μm to about 10 μm, from about 10 μm to about 15 μm, from about 15 μm to about 20 μm, from about 20 μm to about 25 μm, and/or ranges formed from any combination of endpoints thereof. In particular embodiments, the median particle diameter of the electrically-conductive particles of the second phase is less than the median pore diameter of the first phase.

In embodiments, the electrically-conductive material of the second phase comprises electrically-conductive particles also having a defined particle size distribution (Dpb). In embodiments, the particle size distribution may be determined according to the following:

$$Dpb = \frac{dp 50}{dp 90 - dp 10} \qquad ( Eqn . 2 )$$

where dp50 is the median particle size, d90 is the size larger than the smallest 90% of the particles in the distribution, and d10 is the size larger than the smallest 10% of particles in the distribution.

In some embodiments, the particle size distribution (Dpb) is less than or equal to about 1.25 (i.e., Dpb≤1.25), or even less than or equal to about 1.0 (i.e., Dpb≤1.0).

Returning to FIG. 1, after the resistive heater body is provided in a fired or unfired state in the step 110, the method 100 then comprises a step 120 that includes applying an organometallic mixture to at least a first outer surface of the resistive heater body. In embodiments, the step 120 comprises: (1) applying an organometallic mixture to a first outer surface of the resistive heater body, and (2) applying an organometallic mixture to at least a second outer surface of the resistive heater body.

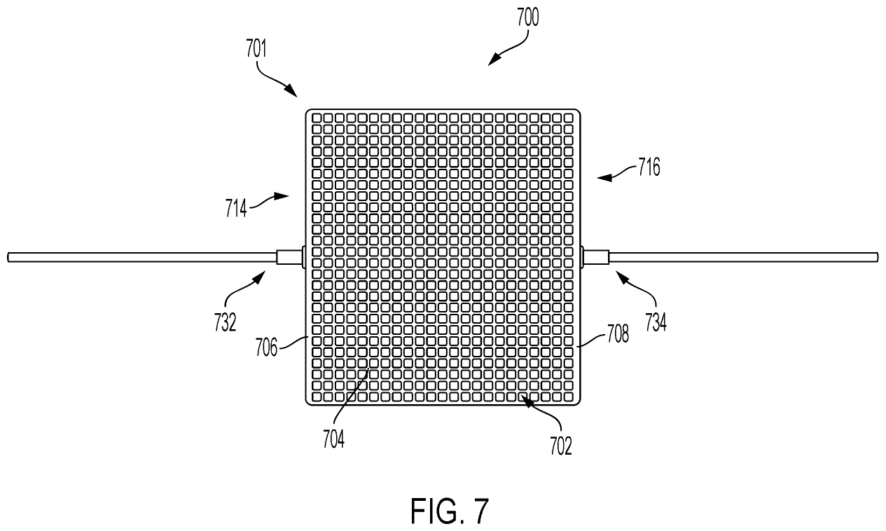

In embodiments, the first outer surface and the second outer surface of the resistive heaters are not continuous regions. Put another way, the organometallic mixture applied to the first outer surface does not contact the organometallic mixture applied to at least the second outer surface. In embodiments, the first outer surface and the second outer surface are disposed at opposing sides of the ceramic honeycomb body (e.g., opposing sides 714, 716 shown in FIG. 7).

In embodiments, the outer surfaces of the resistive heater body where the organometallic mixture is applied are adjacent to porous regions of the resistive heater body where an electrically-conductive material has infiltrated the porosity of interconnected walls. Put another way, in the step 120, an organometallic mixture is applied to one or more outer surfaces of the resistive heater body that are adjacent to porous regions of the resistive heater body where an electrically-conductive material has infiltrated the porosity of interconnected walls.

For example, in some embodiments, the resistive heater body is selectively-skin coated using a slurry comprising metal and/or metal alloy particles, as discussed in more detail below with respect to FIG. 2. Accordingly, one or more porous peripheral regions of the resistive heater body are impregnated with the metal and/or metal alloy particles, which forms the first portion of one or more conductive bases.

In other embodiments, the resistive heater body may comprise a metal ceramic composite material as described. Accordingly, one or more porous peripheral regions of the resistive heater body are impregnated with the electrically-conductive material of the second phase of the resistive heater body. In such embodiments, the electrically-conductive material embedded in the one or more porous peripheral regions forms the first portion of one or more conductive bases.

As described above, the resistive heater bodies of the present disclosure include one or more conductive bases that are suitable for electrode attachment and that include (i) a first portion that infiltrates a peripheral porous region of the resistive heater body, and (ii) a second portion coating an outer surface adjacent to the porous region. Thus, according to the present disclosure, an organometallic mixture is applied one or more exterior surfaces of the resistive heater boy in order to form the second portion of one or more conductive bases.

In embodiments, the organometallic mixture is provided in the form of a slurry or a paste that can be applied to one or more exterior portions of the resistive heater body. In particular embodiments, the organometallic mixture comprises: (i) metal and/or metal alloy particles; (ii) an organic binder; and (iii) a solvent or liquid carrier.

In embodiments, the organometallic mixture comprises metal and/or metal alloy particles. The metal and/or metal alloy particles can include iron, iron alloys, chromium, chromium alloys, nickel, nickel alloys, nickel-chromium alloys, iron-chromium-aluminum (FeCrAl), iron-chromium-aluminum-yttrium (FeCrAlY), Inconel® (e.g., Inconel® 625, etc.), and/or combinations thereof.

In embodiments, the organometallic mixture comprises from about 50 wt % to about 99.9 wt % of the metal and/or metal alloy particles, based on the total weight of the organometallic mixture. In particular embodiments, the organometallic mixture comprises from about 50 wt % to about 55 wt %, from about 55 wt % to about 60 wt %, from about 60 wt % to about 65 wt %, from about 65 wt % to about 70 wt %, from about 70 wt % to about 75 wt %, from about 75 wt % to about 80 wt %, from about 80 wt % to about 85 wt %, from about 85 wt % to about 90 wt %, from about 90 wt % to about 95 wt %, from about 95 wt % to about 99.9 wt %, and/or any combination of endpoints thereof, of the metal and/or metal alloy particles based on the total weight of the organometallic mixture.

In particular embodiments, the metal and/or metal alloy particles of the organometallic mixture can be provided in the form of powder. In embodiments, the metal and/or metal alloy particles can have a mean particle diameter of less than about 30 μm, including less than about 25 μm, less than about 20 μm, less than about 15 μm, less than about 10 μm, and/or less than about 5 μm. In embodiments, the metal and/or metal alloy particles of the first portion have a mean particle diameter of from about 1 μm to about 30 μm, including from about 1 μm to about 5 μm, from about 5 μm to about 10 μm, from about 10 μm to about 15 μm, from about 15 μm to about 20 μm, from about 20 μm to about 25 μm, from about 25 μm to about 30 μm, any combination of endpoints thereof.

In embodiments, the organometallic mixture comprises an organic binder. The organic binder of the organometallic mixture can include one or a mixture of polymers. For example, in embodiments, the organic binder comprises polyvinyl butadiene (PVB), polyvinyl acetate (PVA), polyethylene glycol (PEG), methylcellulose, and the like, including combinations thereof.

In particular embodiments, the organometallic mixture comprises from about 0.1 wt % to about 5.0 wt % of the organic binder, based on the total weight of the organometallic mixture, including from about 0.1 wt % to about 0.2 wt %, from about 0.2 wt % to about 0.3 wt %, from about 0.3 wt % to about 0.4 wt %, from about 0.4 wt % to about 0.5 wt %, from about 0.5 wt % to about 0.6 wt %, from about 0.6 wt % to about 0.7 wt %, from about 0.7 wt % to about 0.8 wt %, from about 0.8 wt % to about 0.9 wt %, from about 0.9 wt % to about 1.0 wt %, from about 1.0 wt % to about 1.5 wt %, from about 1.5 wt % to about 2.0 wt %, from about 2.0 wt % to about 2.5 wt %, from about 2.5 wt % to about 3.0 wt %, from about 3.0 wt % to about 3.5 wt %, from about 3.5 wt % to about 4.0 wt %, from about 4.0 wt % to about 4.5 wt %, from about 4.5 wt % to about 5.0 wt %, and/or any combination of endpoints thereof.

In embodiments, the organometallic mixture comprises a solvent. The solvent of the organometallic mixture can be selected based on its compatibility with the metallic material and the binder, and/or the desired surface tension. In embodiments, the solvent comprises one or a mixture of liquids. For example, in some embodiments, the solvent comprises water, an alcohol, and/or combinations thereof. In particular embodiments, the solvent comprises ethanol.

In embodiments, the organometallic mixture comprises from about 5 wt % to about 30 wt % of the solvent, based on the total weight of the organometallic mixture, including from about 5 wt % to about 10 wt %, from about 10 wt % to about 15 wt %, from about 15 wt % to about 20 wt %, from about 20 wt % to about 25 wt %, from about 25 wt % to about 30 wt %, and/or any combination of endpoints thereof. In particular embodiments, the organometallic mixture comprises a balance amount of the solvent.

Returning to FIG. 1, after applying the organometallic mixture of the resistive heater body in the step 120, the method 100 includes a step 130 that includes drying the component (i.e., the resistive heater body having the applied organometallic mixture). In embodiments, the component is dried at a first temperature for a first period of time. In particular embodiments, the component is dried at a first temperature that is from about 20° C. to about 25° C., including from about 20° C. to about 22° C. In embodiments, the first temperature is room temperature. In further embodiments, the component is dried for a first period of time that is several minutes to several hours, including but not limited to, from about 1 hour to about 2 hours.

After drying the component in the step 130, the method 100 includes a step 140 that comprises heating the component at a second temperature for a second period of time. In embodiments, heating the component in the step 140 sinters the metal and/or metal alloy particles of the organometallic mixture together and sinters the metal and/or metal alloy particles of the organometallic mixture to the electrically-conductive material impregnated into adjacent porous regions of the resistive heater body. Thus, in step 140, heating the component forms one or more conductive bases suitable for electrode attachment in accordance with various aspects of the present disclosure. In particular, the second portion of each conductive base is thereby physically bonded to the first portion of the corresponding conductive base such that the first and second portions are in electrical communication with one another. Accordingly, one or more conductive bases may be formed, such as a first and a second conductive bases. In embodiments, the first and second conductive bases do not contact each other but are in electrical communication with one another and provide suitable contacts for electrode attachment.

In specific embodiments, the component is heated in step 140 to a temperature below the melting point of the materials forming the interconnected walls of the resistive heater body and/or the organometallic mixture. That is, if a metal ceramic composite material was used to form the interconnected walls, then the step 140 comprises heating the component to a temperature that is below the melting point of the organometallic mixture and the metal ceramic composite material. Similarly, if a conductive ceramic material was used to form the interconnected walls, then the step 140 comprises heating the component to a temperature that is below the melting point of the organometallic mixture and the conductive ceramic material.

In particular embodiments, the component is heated at a temperature suitable to sinter the organometallic mixture, preferably 500° C. and 2,000° C., including from about 500° C. to about 750° C., from about 750° C. to about 1,000° C., from about 1,000° C. to about 1,250° C., from about 1,250° C. to about 1,500° C., from about 1,500° C. to about 1,750° C., from about 1,750° C. to about 2,000° C., and ranges formed from any combination of endpoints thereof.

In embodiments, the component is heated for a period of time suitable to sinter a substantial portion of the organometallic mixture, preferably from about 30 minutes to about 12 hours, and more preferably less than about 6 hours. In embodiments, the heating period of time can be from about 30 minutes to about 1 hour, from about 1 hour to about 2 hours, from about 2 hours to about 3 hours, from about 3 hours to about 4 hours, from about 4 hours to about 5 hours, from about 5 hours to about 6 hours, from about 6 hours to about 7 hours, from about 7 hours to about 8 hours, from about 8 hours to about 9 hours, from about 9 hours to about 10 hours, from about 10 hours to about 11 hours, from about 11 hours to about 12 hours, and ranges formed from any combination of endpoints thereof.

In embodiments, at least a portion of step 140 is performed under an inert environment such as an argon (Ar) atmosphere. In specific embodiments, for example and without limitation, the step 140 can be performed under an inert environment (e.g., Argon atmosphere) at about 1,300° C. for about 6 hours.

In embodiments, the method 100 further comprises, in a step 150, coupling one or more electrodes to the resistive heater body having one or more conductive bases formed at an outer periphery of the resistive heater body. In embodiments, each electrode can be coupled to a corresponding conductive base of the resistive heater body by a metal-to-metal welding process.

For example, in particular embodiments, at least a first conductive base and at least a second conductive base can be formed at an outer periphery of a resistive heater body as described above, and in the step 150, the method 100 comprises coupling a first electrode to a first conductive base and coupling at least a second electrode to the second conductive base. These conductive bases can provide suitable electrical contacts between the electrodes and the intersecting walls. For example, as described herein, the electrodes must be able to be attached to the resistive heater body in order to provide an electrical current and produce heat. Further, the conductive bases are adapted to provide suitable electrode attachment points for use in harsh conditions, including but not limited to, extreme thermal cycling, constant vibrations, exposure to a wet/high-moisture environment, and exposure to significant electrical currents.

Turning to FIG. 2, also provided herein are methods 200 of selectively skin coating an outer periphery of a resistive heater body with a slurry containing metal and/or metal alloy particles. In embodiments, the slurry containing metal and/or metal alloy particles are used according to these methods to form impregnate one or more peripheral porous regions of the resistive heater body with the metal and/or metal alloy particles. That is, the slurry containing metal and/or metal alloy particles are used according to these methods to form the first portion of at least one conductive base. Accordingly, it should be appreciated that one or more steps of the method 200 may be performed prior to one or more steps of the method 100. For example, in some embodiments, a resistive heater body is formed in step 110 of the method 100, which is then selectively skin coated according to the method 200 prior to applying an organometallic mixture in step 120 and forming the conductive bases according to steps 120-150 of the method 100.

As shown in the example of FIG. 2, a method 200 of selectively skin coating an outer periphery of a resistive heater body is illustrated according to certain aspects of the present disclosure. In embodiments, the method 200 comprises: in a step 210, masking one or more faces of the resistive heater body; in a step 220, mounting the resistive heater body into a vacuum fixture; in a step 230, submerging at least a portion of the resistive heater body into a slurry containing metal and/or metal alloy particles; in a step 240, applying a vacuum pressure to the resistive heater body; in a step 250, removing the resistive heater body from the slurry; and in a step 260, drying the resistive heater body. In embodiments, the resistive heater body is unmounted from the vacuum fixture and/or one or more steps 210-260 are repeated.

In embodiments, the method 200 comprises a step 210 comprising masking a first end face of a resistive heater body. As described above, the resistive heater body can comprise a plurality of openings formed by interconnected walls. In embodiments, the plurality of openings are channels that open at a first end face of the resistive heater body. Thus, it should be appreciated that masking a first end face of the resistive heater body prevents material (e.g., the slurry comprising metal and/or metal alloy particles) from entering the resistive heater body via the openings at the first end face.

In specific embodiments, the resistive heater body can be formed from a conductive ceramic material (CCM) using an extrusion process to form a ceramic substrate. In embodiments, the ceramic substrate can also comprise thickened cell walls disposed along an outer perimeter of the ceramic substrate. The thickened cell walls disposed along the outer perimeter of the ceramic substrate can be referred to herein as a “skin” of the substrate. However, it should be appreciated that the honeycomb substrate, including the skin portion, has an average bulk porosity of at least about 40%, as described above.

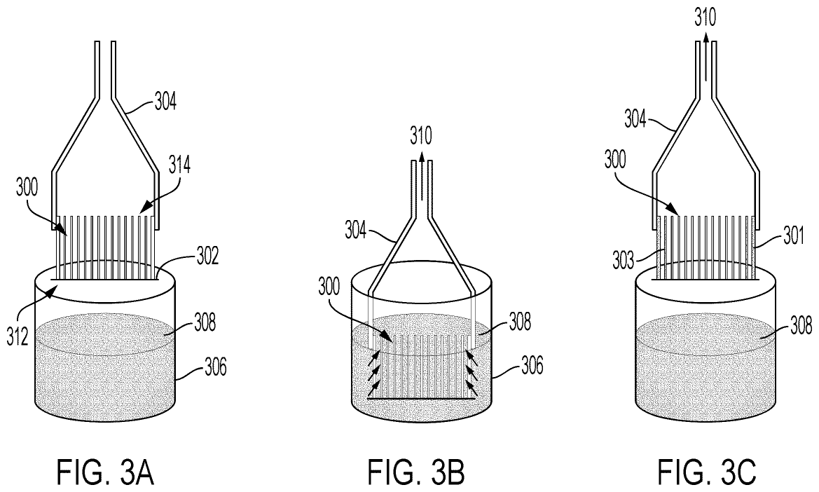

In particular embodiments, step 210 includes applying a non-porous masking sheet to an end face of the resistive heater body that leaves an outer periphery of the resistive heater body exposed. For example, as shown in FIG. 3A, a non-porous masking sheet 302 has been applied to an end face 312 of the resistive heater body 300, which leaves an outer periphery 301 of the resistive heater body 300 exposed.

In embodiments, the method 200 comprises a step 220 that includes mounting the resistive heater body into a vacuum fixture at a second end face of the resistive heater body. In embodiments, the resistive heater body is mounted such that a vacuum pressure can be applied to the resistive heater body. In further embodiments, the second end face is opposing/opposite that of the masked first end face.

For example, as shown in FIG. 3A, the resistive heater body 300 is mounted to a vacuum fixture 304 at a second end face 314 of the resistive heater body 300 such that a vacuum pressure 310 can be applied to the resistive heater body 300. In embodiments, the second end face 314 is opposite the first end face 312. In further embodiments, the resistive heater body may comprise cell channels that extend between the first and second end faces, as shown in FIG. 3A. However, it should be appreciated that other arrangements of openings, channels, and interconnected walls are contemplated as described above.

In embodiments, the method 200 comprises a step 230 that includes submerging at least a portion of the resistive heater body into a slurry containing metal and/or metal alloy particles. In embodiments, the resistive heater body is submerged such that the slurry contacts an outer periphery of the resistive heater body while mounted to the vacuum fixture. For example, as shown in FIG. 3B, the resistive heater body 300 is submerged into a vessel 306 containing a slurry 308 while mounted to the vacuum fixture 304.

In particular embodiments, the slurry (e.g., slurry composition 308) used to selectively skin coat the resistive heater body comprises electrically-conductive metal and/or metal alloy particles. In further embodiments, the slurry also comprises one or more of a solvent, an organic stabilizer, and/or an organic binder.

In embodiments, the metal and/or metal alloy particles of the slurry can comprise, for example and without limitation, iron, iron alloys, chromium, chromium alloys, nickel, nickel alloys, nickel-chromium alloys, iron-chromium-aluminum (FeCrAl), iron-chromium-aluminum-yttrium (FeCrAlY), Inconel® (e.g., Inconel® 625, etc.), and/or combinations thereof.

In embodiments, the slurry can comprise from about 50 wt % to about 95 wt % of the metal and/or metal alloy particles based on the total weight of the slurry. More specifically, the slurry can comprise from about 50 wt % to about 95 wt % of the metal and/or metal alloy particles, including from about 50 wt % to about 55 wt %, from about 55 wt % to about 60 wt %, from about 60 wt % to about 65 wt %, from about 65 wt % to about 70 wt %, from about 70 wt % to about 75 wt %, from about 75 wt % to about 80 wt %, from about 80 wt % to about 85 wt %, from about 85 wt % to about 90 wt %, from about 90 wt % to about 95 wt %, and/or ranges having any combination of endpoints thereof. In particular embodiments, the slurry comprises a balance amount of the metal and/or metal alloy particles.

In some embodiments, the median particle diameter of the metal and/or metal alloy particles is less than the median pore diameter of the resistive heater body. In particular embodiments, the median particle diameter of the metal and/or metal alloy particles is less than the median pore diameter of the porous peripheral regions of the resistive heater body that are being coated (i.e., including at least the exposed portions of the resistive heater body).

In embodiments, the median pore diameter of the resistive heater body and/or the porous peripheral region(s) can be from about 10 μm to about 25 μm, and the median particle diameter of the metal and/or metal alloy particles is at most 30 μm.

In embodiments, the metal and/or metal alloy particles can have a median particle diameter of less than about 30 μm, including less than about 25 μm, less than about 20 μm, less than about 15 μm, less than about 10 μm, and/or less than about 5 μm. In embodiments, the metal and/or metal alloy particles have a median particle diameter of from about 1 μm to about 30 μm, including from about 1 μm to about 2 μm, from about 2 μm to about 3 μm, from about 3 μm to about 4 μm, from about 4 μm to about 5 μm, from about 5 μm to about 6 μm, from about 6 μm to about 7 μm, from about 7 μm to about 8 μm, from about 8 μm to about 9 μm, from about 9 μm to about 10 μm, from about 10 μm to about 15 μm, from about 15 μm to about 20 μm, from about 20 μm to about 25 μm, from about 25 μm to about 30 μm, and/or ranges having any combination of endpoints thereof.

In embodiments, the median pore diameter of the resistive heater body and/or the porous peripheral region(s) can be at least about 5 μm, including at least about 10 μm, at least about 15 μm, at least about 20 μm, and/or at least about 25 μm. In some embodiments, the resistive heater body can have a median pore diameter of from about 5 μm to about 10 μm, from about 10 μm to about 15 μm, from about 15 μm to about 20 μm, from about 20 μm to about 25 μm, and ranges having any combination of endpoints thereof.

In embodiments, the slurry further comprises a solvent. The solvent can be, for example and without limitation, ethanol, methanol, propanol, water, and/or combinations thereof. In particular embodiments, the slurry comprises from about 5 wt % to about 30 wt % of the solvent, based on the total weight of the slurry, including from about 5 wt % to about 10 wt %, from about 10 wt % to about 15 wt %, from about 15 wt % to about 20 wt %, from about 20 wt % to about 25 wt %, from about 25 wt % to about 30 wt %, and/or ranges having any combination of endpoints thereof. In particular embodiments, the slurry comprises a balance amount of the solvent.

In embodiments, the slurry further comprises an organic stabilizer. The organic stabilizer can be, for example and without limitation, at least one saturated fatty acid. In embodiments, the organic stabilizer is at least one of stearic acid, lauric acid, myristic acid, palmitic acid arachidic acid, and/or combinations thereof. In embodiments, the slurry comprises from about 1 wt % to about 5 wt % of the organic stabilizer based on the total weight of the slurry, including from about 1.0 wt % to about 1.5 wt %, from about 1.5 wt % to about 2.0 wt %, from about 2.0 wt % to about 2.5 wt %, from about 2.5 wt % to about 3.0 wt %, from about 3.0 wt % to about 3.5 wt %, from about 3.5 wt % to about 4.0 wt %, from about 4.0 wt % to about 4.5 wt %, from about 4.5 wt % to about 5.0 wt %, and/or ranges having any combination of endpoints thereof. In particular embodiments, the slurry comprises a balance amount of the organic stabilizer.

In embodiments, the slurry further comprises an organic binder. The organic binder of the slurry can comprise one or a mixture of polymers. For example, the organic binder can comprise polyvinyl butadiene (PVB), polyvinyl acetate (PVA), polyethylene glycol (PEG), methylcellulose, modified polyurethane (e.g., Disperbyk®-185, etc.), saturated fatty acids (e.g., stearic acid, etc.), and the like, including combinations thereof.

In embodiments, the slurry comprises from about 0.1 wt % to about 5.0 wt % of the organic binder, based on the total weight of the slurry, including from about 0.1 wt % to about 0.5 wt %, from about 0.5 wt % to about 1.0 wt %, from about 1.5 wt % to about 2.0 wt %, from about 2.0 wt % to about 2.5 wt %, from about 2.5 wt % to about 3.0 wt %, from about 3.0 wt % to about 3.5 wt %, from about 3.5 wt % to about 4.0 wt %, from about 4.0 wt % to about 4.5 wt %, from about 4.5 wt % to about 5.0 wt %, and/or ranges having any combination of endpoints thereof. In particular embodiments, the slurry comprises a balance amount of the organic binder.

Returning to FIG. 2, the method 200 comprises a step 240 comprising applying a vacuum pressure to the resistive via the vacuum fixture at least while a portion of the resistive heater body is submerged in the slurry. In particular embodiments, the vacuum pressure can be applied to the resistive heater body before the resistive heater body is submerged into the slurry, while the resistive heater body is being submerged into the slurry, or once the resistive heater body is already submerged into the slurry. Put another way, step 240 can be performed before, during, or after step 230 of the method 200.

In particular embodiments, the vacuum pressure applied to the resistive heater body can be such that the metal and/or metal alloy particles of the slurry are drawn into the interconnected porosity of the exposed portions of the resistive heater body. For example, as shown in FIG. 3B, a vacuum pressure 310 is applied to the resistive heater body 300 at least while the resistive heater body 300 is submerged in the slurry 308 such that the slurry (or a portion thereof) is drawn into the porous, outer periphery portions of the resistive heater body 300. Put another way, the vacuum pressure applied to the resistive heater body is such that the metal and/or metal alloy particles of the slurry infiltrate or are otherwise impregnated into the porous peripheral regions of the resistive heater body.

In particular embodiments, the resistive heater body 300 comprises a thicker but porous skin 301, and the vacuum pressure applied to the resistive heater body 300 is such that the slurry 308 (or a portion thereof) is drawn into at least the skin portion 301 of the resistive heater body 300. In further embodiments, the vacuum pressure applied to the resistive heater body 300 can be such that the slurry 308 (or a portion thereof) is drawn further into the resistive heater body 300, including into an interior cell walls 303 of the resistive heater body 300.

In embodiments, the vacuum pressure can be from about 1 psi to about 10 psi, including from about 1 psi to about 2 psi, from about 2 psi to about 3 psi, from about 3 psi to about 4 psi, from about 4 psi to about 5 psi, from about 5 psi to about 6 psi, from about 6 psi to about 7 psi, from about 7 psi to about 8 psi, from about 8 psi to about 9 psi, from about 9 psi to about 10 psi, and/or ranges having any combination of endpoints thereof. In particular embodiments, the vacuum pressure is from about 1 psi to about 5 psi, preferably about 3 psi.

In embodiments, the method 200 then comprises a step 250 comprising removing the coated resistive heater body from the slurry. In some embodiments, the coated resistive heater body can be removed from the slurry while the vacuum pressure is still being applied. For example, as shown in FIG. 3C, the honeycomb substrate 300 having a coated outer peripheral region 301, 303 is removed from the slurry 308 while the vacuum pressure 310 is still being applied to the honeycomb substrate 300. In other embodiments, the vacuum pressure is terminated before the coated resistive heater body is removed from the slurry in the step 250.

In embodiments, the method 200 then comprises a step 260 comprising drying the coated resistive heater body at a first temperature for a first period of time. In some embodiments, the resistive heater body can be dried at a first temperature of from about 30° C. to about 150° C., including from about 80° C. to about 110° C. In some embodiments, the resistive heater body can be dried for a period of time of from about 1 hour to about 2 hours. In particular embodiments, drying the coated resistive heater body in step 260 can comprise unmounting the coated resistive heater body from the vacuum fixture (e.g., vacuum fixture 304) and moving the coated resistive heater body to a drying station and/or vessel.

As shown in the example of FIG. 2, one or more steps of the method 200 can be repeated one or more times. For example, in some embodiments, the method 200 comprises repeating steps 230-260 one or multiple times until the slurry effectively infiltrates the porous peripheral region(s) of the resistive heater body. In some embodiments, the method 200 can comprise repeating steps 220-260 one or multiple times, for example, when drying the coated resistive heater body involves unmounting the coated resistive heater body.

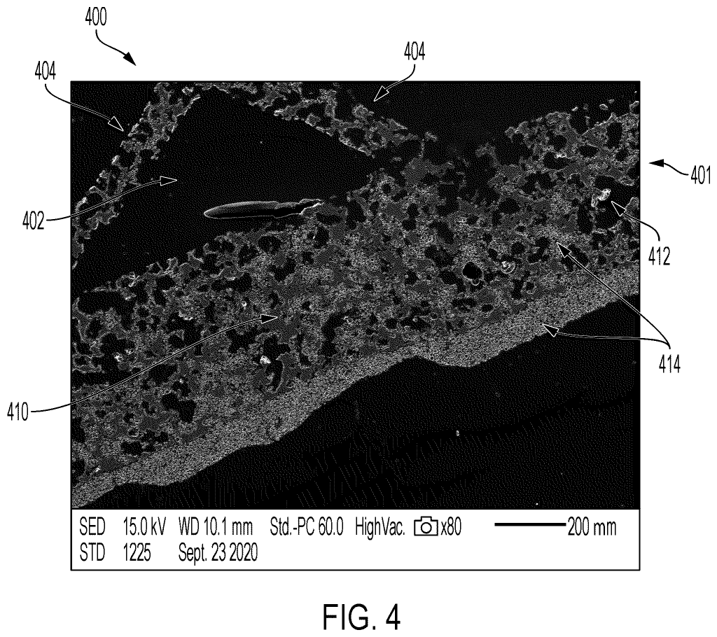

As described herein, the method 200 of selectively skin coating a resistive heater body results in a resistive heater body having metal and/or metal alloy particles embedded into one or more porous peripheral regions of the resistive heater body. As described above, in certain embodiments, these metal and/or metal alloy particles form the first portion of one or more conductive bases suitable for electrode attachment. With reference to FIG. 4, a scanning electron microscope (SEM) image of a selectively coated skin 401 of a resistive heater body 400 formed according to the method 200 is shown. In particular, the resistive heater body 400 comprises cell channels 402 defined by intersecting cell walls 404, and a selectively coated skin 401 along an outer periphery of the honeycomb substrate 400. In the example of FIG. 4, the skin 401 and cell walls 402 are formed from a conductive ceramic material 410 having an interconnected porosity (e.g., pores 412) which are at least partially filled by the metal and/or metal particles 414 of the slurry, as described above.

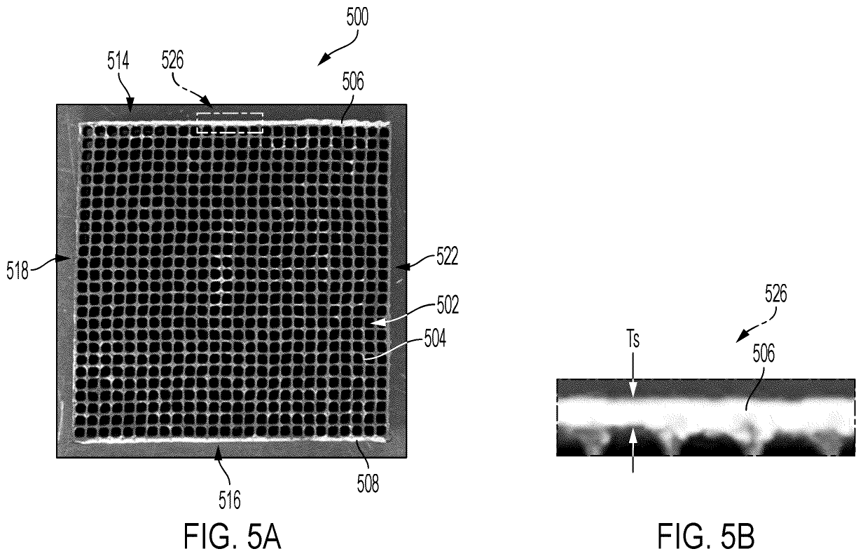

With reference to FIGS. 5A and 5B, a resistive heater body 500 having a first conductive base 506 and a second conductive base 508 formed thereon in accordance with the methods described herein is illustrated. As shown, the honeycomb body 500 comprises a plurality of cell channels 502 formed by a plurality of intersecting cell walls 504, a first conductive base 506 formed at a first outer periphery 514 of the resistive heater body 500, and a second conductive base 508 formed at a second outer periphery 516 of the resistive heater body 500. In embodiments, the first and second conductive bases 506, 508 are continuous metallic layers 506, 508 that are advantageously disposed on opposing ends 514, 516 of the resistive heater body 500. In the example of FIG. 5A, the honeycomb body 500 has a rectangular shape (i.e., a rectangular cross-section), with sides 518, 522 that do not have continuous metallic layers, and sides 514, 516 that do have continuous metallic layers. However, it should be appreciated that the honeycomb body 500 can have other shapes and/or cross-sections, as described herein. Nevertheless, because the conductive bases 506, 508 will provide electrode attachment points allowing current to flow from one end 514 of the resistive heater body 500 to the opposite end 516 of the resistive heater body 500, this arrangement maximizes a uniform flow and distribution of electrical current through the resistive heater body.

With reference to FIG. 5B, an enlarged illustration of the portion 526 of FIG. 5A is shown. In particular, FIG. 5B shows a peripheral region of the resistive heater body 500 that comprises a conductive base 506 having a first and second portion as described above, resulting in an increased thickness along the conductive base relative to the interconnected walls 504. In embodiments, the conductive bases (e.g., continuous metallic layers 506, 508) have an average thickness T_{S} of from about 5 mils to about 25 mils, including from about 5 mils to about 10 mils, from about 10 mils to about 15 mils, from about 15 mils to about 20 mils, from about 20 mils to about 25 mils, and/or ranges having any combination of endpoints thereof.

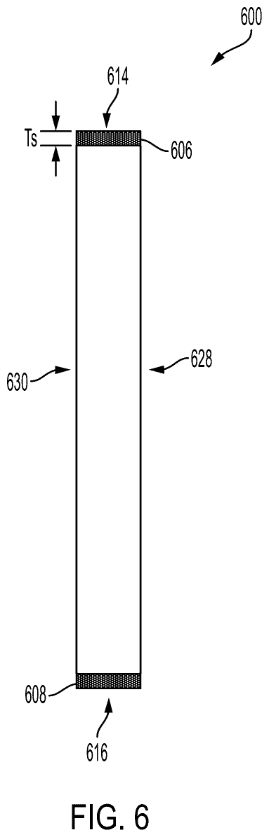

Similarly, with reference to FIG. 6, an illustration representing a side view of a resistive heater body 600 is shown according to aspects of the present disclosure. In particular, the resistive heater body 600 has a first conductive base 606 formed at a first outer periphery 614 of the resistive heater body 600 and a second conductive base 608 formed at a second outer periphery 616 of the resistive heater body 600. In embodiments, the resistive heater body 600 has a first end face 628 and a second end face 630. As described above, the plurality of cell channels (e.g., cell channels 502) of the resistive heater body 600 can be parallel to one another and extend in an axial direction through the resistive heater body 600 between opposite end faces 628, 630 of the body 600 (e.g., from a first end face 628 to a second end face 630).

Also provided herein are resistive heater assemblies comprising a resistive heater body having a first and second conductive base as described above. In particular, such resistive heater assemblies comprise: (i) a resistive heater body comprising a first conductive base formed at a first side of the resistive heater body and a second conductive base formed at a second side of the resistive heater body; (ii) a first electrode coupled to the first conductive base at the first side of the resistive heater body; and (iii) a second electrode coupled to the second conductive base at the second side of the resistive heater body. As described herein, each conductive base (e.g., continuous metallic layers 706, 708) can provide a suitable electrical contact between a corresponding electrode and the intersecting cell walls such that an electrical current can flow from one electrode to an opposing electrode via the electrically-conductive material of the intersecting cell walls. Further, as described herein, the conductive bases are adapted for use in harsh conditions, including but not limited to, extreme thermal cycling, constant vibrations, exposure to a wet/high-moisture environment, and exposure to significant electrical currents.

For example, with reference to FIG. 7, a resistive heater assembly 700 is illustrated according to aspects of the present disclosure. As shown, the resistive heater assembly 700 comprises a resistive heater body 701 comprising a first conductive base 706 formed at a first side 714 of the resistive heater body 701 and a second conductive base 708 formed at a second side 716 of the resistive heater body 701; (ii) a first electrode 732 coupled to the first conductive base 706 at the first side 714 of the resistive heater body 701; and (iii) a second electrode 734 coupled to the second conductive base 708 at the second side 716 of the resistive heater body 701. In embodiments, each of the conductive bases 706, 708 are continuous metallic layers formed as described above.

In the example of FIG. 7, the resistive heater body 701 comprises a plurality of cell channels 702 formed by a plurality of intersecting cell walls 704. The plurality of cell channels 702 of the resistive heater body 701 can be parallel to one another and extend in an axial direction through the resistive heater body 701 between opposite end faces of the body (e.g., end faces 628, 630 shown in FIG. 6). The cell channels 702 can have a rectangular cross-sectional shape, but can also have other regular or irregular cross-sectional shapes, including but not limited to, triangular, heptagonal, hexagonal, octagonal, trapezoidal, diamond, circular, ellipsoidal, other polygonal shapes, and/or combinations thereof. Although the resistive heater body 701 is illustrated as having a rectangular peripheral shape, it should be appreciated that the resistive heater body 701 can have other peripheral shapes, including but not limited to circular, triangular, heptagonal, hexagonal, octagonal, trapezoidal, diamond, circular, ellipsoidal, or another polygonal shape.

In embodiments, each electrode 732, 734 can be coupled to a conductive base 706, 708 of the resistive heater body 701 by a metal-to-metal welding process.

In embodiments, the resistive heater assembly 700 can be configured to receive an electrical current via the electrodes 732, 734 and produce heat. As the conductive bases 706, 708 attached to the electrodes 732, 734 are in contact with the full skin surfaces 714, 716, the resistive heater assembly 700 can result in a uniform distribution of the current across the honeycomb body 701 and, therefore, in a more uniform heating of the resistive heater body 701.

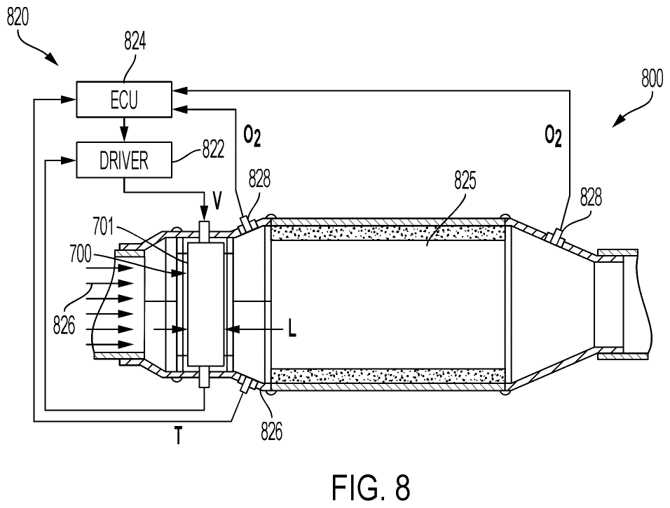

Also provided herein are fluid treatment systems comprising a resistive heater assembly 700 as described herein. In particular, the fluid treatment systems can be adapted to minimize light-off timing of an associated fluid treatment component (e.g., a catalyst-containing substrate) and thereby reduce undesirable emissions. For example, with reference to FIG. 8, a cross-sectional side view of a fluid treatment system 800 comprising a catalyst-containing substrate 825 and a resistive heater assembly 700 is illustrated according to aspects of the present disclosure.

In embodiments, the catalyzed substrate 825 can be a flow-through type of honeycomb substrate (e.g., having a plurality of channels formed by intersecting cell walls), which contains a catalyst material useful for capturing undesirable emissions from a fluid flow via a chemical reaction. In some embodiments, a catalyst material is also included in and/or on the walls of the cell channels, for example, by washcoating. The catalyst material can comprise one or more metal materials that operate to reduce a concentration of an exhaust pollutant in a flow of an exhaust gas, including but not limited to, nitrogen oxides (NOx), carbon monoxide (CO), and unburned hydrocarbons. The catalyst material can be a selective catalyst reduction (SCR) catalysts. In some embodiments, the catalyst material can be a metal component that is selected from the group consisting of platinum, palladium, rhodium, ruthenium, iridium, and combinations thereof, for example. In embodiments, the catalyst metal material can be gold, silver, copper, or iron. Other oxide catalyst materials such as oxides of aluminum, zeolite, ceria, lithium, magnesium, calcium, manganese, cobalt, nickel, copper, zinc, and silver can also be included as part of a catalyst washcoat. In some embodiments, the catalyst oxide material of the washcoat can be a SOx sorbent component such as Mg or MnO₂, for example.

In embodiments, the resistive heater assembly 700 can be positioned adjacent to the catalyst substrate 825 such that the resistive heater assembly 700 having a thickness ‘L’ is upstream from the catalyst substrate 825. As such, a fluid flow 823 passing through the fluid treatment system 800 can flow through the cell channels 702 of the resistive heater body 701 before reaching the cell channels of the catalyst substrate 825. Put another way, the resistive heater assembly 700 can be positioned and configured to receive a fluid flow 823 (e.g., into a plurality of cell channels 702 of the resistive heater body 701) at a first end face (e.g., end face 628 shown in FIG. 6), and communicate the fluid flow 823 out of a second end face (e.g., end face 730 shown in FIG. 6) to the catalyst substrate 825.

In embodiments, an electrical potential can be applied to the resistive heater body 701 by a control system 820 comprising a voltage driver 822 that is connected to the resistive heater body 701 via electrodes 732, 734. That is, the control system 820 is operatively connected to the resistive heater assembly 700 and is configured to drive power to the heater assembly 700 at appropriate times (e.g., at various times during or before operation of an engine coupled to the fluid treatment system 800). In embodiments, the control system 820 is configured to control the timing, duration, and/or magnitude of the potential (e.g., a voltage ‘V’) applied to the resistive heater body 701.

In particular embodiments, the control system 820 further comprises an engine control unit (ECU) 824. In embodiments, the voltage driver 822 of the control system 820 can control the potential applied to the resistive heater body 701 according to a desired thermal profile provided by the engine control unit 824. The thermal profile can be adapted to reduce cold-start emissions by, for example, applying a potential to the resistive heater body 701 such that the fluid flow 823 reaches a minimum temperature within a predetermined period of time. the minimum temperature achieved can be from about 250° C. to about 650° C., and the predetermined period of time is between about 1.0 second and about 10 seconds. In further embodiments, the minimum temperature to be achieved via the resistive heater assembly 200 can be determined as a function of the flow rate of the exhaust gas 823, temperature of the gas flow 823 at the inlet of the body, heat transfer coefficient between the resistive heater body 701 and the gas flow 823, and applied power based on a goal or desired outcome. For example, the control system 820 can receive one or more inputs from temperature sensors 826 (measuring temperature ‘T’) and/or gas sensors 828 (measuring, for example, oxygen ‘O₂’) distributed at various points within the treatment system 800.

### Definitions

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A resistive heater body, comprising:
a plurality of channels formed by interconnected walls, wherein the interconnected walls comprise a ceramic-containing material;
a first conductive base comprising: (i) a first portion infiltrating a first porous peripheral region of the resistive heater body, and (ii) a second portion coating a first surface of the resistive heater body adjacent to the first porous peripheral region, wherein the second portion is formed from an organometallic mixture; and
a second conductive base comprising: (i) a first portion infiltrating a second porous peripheral region of the resistive heater body, and (ii) a second portion coating a second surface of the resistive heater body adjacent to the second porous peripheral region, wherein the second portion is formed from the organometallic mixture.

2. The resistive heater body of claim 1, wherein the plurality of channels are cell channels and the interconnected walls are cell walls.

3. The resistive heater body of claim 1, wherein the plurality of channels extend in an axial direction through the resistive heater body from a first end face of the resistive heater body to a second end face of the resistive heater body.

4. The resistive heater body of claim 1, wherein the interconnected walls of the resistive heater body are formed from a conductive ceramic material and have an average bulk porosity of from about 40% to about 80%.

5. The resistive heater body of claim 4, wherein the first portion of the first conductive base and the first portion of the second conductive base are formed from a slurry comprising metal and/or metal alloy particles.

6. The resistive heater body of claim 5, wherein the interconnected walls have a median pore diameter of about 5 μm to about 35 μm and the metal and/or metal alloy particles have a median particle diameter of from about 1 μm to about 35 μm.

7. The resistive heater body of claim 5, wherein the interconnected walls have a median pore diameter that is greater than a median particle diameter of the metal and/or metal alloy particles.

8. The resistive heater body of claim 1, wherein the interconnected walls of the resistive heater body are formed from (i) a first phase of a porous material defining an internal, interconnected porosity, and (ii) a second phase of an electrically-conductive material that at least partially fills the internal, interconnected porosity of the first phase.

9. The resistive heater body of claim 8, wherein the internal, interconnected porosity of the first phase has a median pore diameter of from about 5 μm to about 40 μm, and the electrically-conductive material of the second phase comprises electrically-conductive particles having a median particle diameter of from about 0.5 μm to about 25 μm.

10. The resistive heater body of claim 1, wherein the organometallic mixture comprises from about 50 wt % to about 95 wt % of metal and/or metal alloy particles.

11. The resistive heater body of claim 10, wherein the metal and/or metal alloy particles comprises iron, iron alloys, chromium, chromium alloys, nickel, nickel alloys, nickel-chromium alloys, iron-chromium-aluminum (FeCrAl), iron-chromium-aluminum-yttrium (FeCrAlY), an Inconel® alloy, and/or combinations thereof.

12. The resistive heater body of claim 1, wherein the organometallic mixture comprises from about 0.1 wt % to about 5 wt % of an organic binder.

13. The resistive heater body of claim 12, wherein the organic binder comprises polyvinyl butadiene (PVB), polyvinyl acetate (PVA), polyethylene glycol (PEG), methylcellulose, and/or combinations thereof.

14. The resistive heater body of claim 1, wherein the organometallic mixture comprises from about 5 wt % to about 30 wt % of a solvent.

15. The resistive heater body of claim 14, wherein the solvent comprises at least one of an alcohol and water.

16. A resistive heater assembly comprising a resistive heater body of claim 1, further comprising: (i) a first electrode coupled to the first conductive base of the resistive heater body, and (ii) a second electrode coupled to the second conductive base of the resistive heater body.

17. A fluid treatment system comprising the resistive heater assembly of claim 16.

18. A method of selectively coating an outer periphery of a resistive heater body, the method comprising:
masking a first end face of the resistive heater body, the resistive heater body comprising a plurality of channels formed by interconnected walls, wherein the interconnected walls comprise a ceramic-containing material;
mounting the resistive heater body into a vacuum fixture at the second end face of the resistive heater body;
while mounted to the vacuum fixture, submerging at least a portion of the resistive heater body into a slurry such that the slurry contacts at least an outer periphery of the resistive heater body, wherein the slurry comprises metal and/or metal alloy particles;
applying a vacuum pressure to the resistive heater body via the vacuum fixture at least while the portion of the resistive heater body is submerged in the slurry;
removing the resistive heater body from the slurry; and
drying the resistive heater body at a first temperature for a first period of time.

19. The method of claim 15, wherein one or more steps are repeated a plurality of times.

20. A method of manufacturing a resistive heater body having one or more conductive bases formed at one or more outer surfaces of the resistive heater body, the method comprising:
providing a resistive heater body, wherein the resistive heater body comprises: (i) a plurality of channels formed by interconnected walls, wherein the interconnected walls comprise a ceramic-containing material; and (ii) a conductive material infiltrating at least a first porous peripheral region of the resistive heater body;
applying an organometallic mixture to at least a first surface of the resistive heater body adjacent to at least the first porous peripheral region of the resistive heater body;
drying the resistive heater body and the applied organometallic mixture at a first temperature for a first period of time; and
heating the ceramic honeycomb body and the applied organometallic mixture at a second temperature for a second period of time to sinter the conductive material infiltrating at least the first porous peripheral region of the resistive heater body to the organometallic mixture and thereby form at least a first conductive base.
